(19) United States
(12) Patent Application Publication
(10) Pub. No.: US 2016/0358281 A1
(43) Pub. Date: Dec. 8, 2016

(54) COMPUTERIZED SYSTEM AND METHOD FOR MANAGING MEDICAL RECORDS

(71) Applicants: JIMMIE DALE BOWYER, II, Jeffersonville, IN (US); BRENT K. HEEZEN, Green Bay, WI (US); VANESSA A. MILLS, Little Chute, WI (US); NANCY SCHULER MOELLER, Louisville, KY (US); JOHN WESLEY WHITMIRE, Louisville, KY (US)

(72) Inventors: JIMMIE DALE BOWYER, II, Jeffersonville, IN (US); BRENT K. HEEZEN, Green Bay, WI (US); VANESSA A. MILLS, Little Chute, WI (US); NANCY SCHULER MOELLER, Louisville, KY (US); JOHN WESLEY WHITMIRE, Louisville, KY (US)

(73) Assignee: HUMANA INC., Louisville, KY (US)

(21) Appl. No.: 12/979,949

(22) Filed: Dec. 28, 2010

(51) Int. Cl. G06Q 50/00; G06Q 10/00

(52) U.S. Cl. CPC G06Q 50/22

(57) ABSTRACT

A computerized system and method for managing requests for medical records and the fulfillment of requests. Multiple users can submit requests for records and view requests already made by other users, and any records received in response to requests. Requests can be searched based on different criteria and reports can be generated regarding requests. Pending requests may be edited to the extent they do not meet the needs of users. Requests may be consolidated and batched together before being sent to a provider. Providers can receive notifications regarding requests that are outstanding. A provider can review requests made, upload records responsive to requests, and delete requests.

### CROSS-REFERENCE TO RELATED APPLICATIONS

None.

### BACKGROUND OF THE INVENTION

It is often necessary for a business to solicit information or data from third parties with which it works in order to fulfill its purpose. For example, healthcare plan and benefits companies often need to solicit information about insurance claims from third party healthcare providers. The healthcare providers may be doctors' offices, hospitals, dentists' offices, or any other provider whose services are the basis of a claim that must be substantiated before the provider can be reimbursed according to plan provisions. Depending on the amount of claims associated with a patient, and the different tasks involved in reviewing and substantiating the claims, different business units at a healthcare plan or benefits company may need different types of information from a healthcare provider at different times. Numerous solicitations to healthcare providers for different information pertaining to a particular patient can cause confusion, mistake, and overburden the healthcare provider. Providers may also receive multiple requests for the same or similar information from different business units at a healthcare plan or benefits company, unnecessarily duplicating the amount of time a provider must spend on obtaining and providing the information. There may be different ways in which a provider receives requests, such as by e-mail, telephone, fax, or postal mail. A provider may similarly provide information to the healthcare plan or benefits company in different ways. The inconsistent ways in which information is requested and provided can further exacerbate the difficulties with tracking what information has been requested and received regarding a patient. All of the difficulties discussed above can cause delays and make it difficult for claims to be adjudicated in a timely manner. These problems also make it difficult for either the healthcare plan or benefits company or the healthcare provider to keep a record of the information that has been requested from all different health insurance departments, which requests have been fulfilled, and which requests are outstanding. There is a need for a system and method for managing medical records requests and information.

### SUMMARY OF THE INVENTION

The present invention is a computerized system and method for managing medical records requests and related information. In one embodiment a server receives requests for patient information from multiple users, consolidates requests to the extent they are duplicative, submits the requests to a provider, receives patient information from the provider, stores the information, and allows users to access stored information. Channel management allows users to select the preferred approach to contacting the provider. Providers may provide information from computers, which may allow the user to delete requests for patient information. Requests for information may be batched by users. Also, servers may be able to search patient information that has been received from providers. Another embodiment is a method for gathering information about a patient from a provider. The method consists of receiving requests for information about a patient, storing the requests on a server, providing the user with access to the requests, selecting a subset of requests for information and sending that subset to a provider. Information is received from the provider and stored on a server where it can be accessed by users. Requests that have been fulfilled by the provider can be identified and workflow features allow users to use the record within their business process. Access to received information, which may include medical records, may require a user to meet pre-determined criteria, such as being on an approved list of users. The system may also create reports on requests (e.g., tracking use for Minimum Necessary).

### BRIEF DESCRIPTION OF THE DRAWINGS

FIG. 1 is a block diagram demonstrating the prior art.

FIG. 2 is a block diagram of an exemplary embodiment of a records request system.

FIG. 3 is a sample home page of a web interface of an exemplary embodiment.

FIG. 4 is a sample worklist page of web interface of an exemplary embodiment.

FIG. 5 is a top section of a sample verify request page of an exemplary embodiment.

FIG. 6 is a sample medical record viewer page of an exemplary embodiment.

FIG. 7 is a bottom section of a sample verify request page of an exemplary embodiment.

FIG. 8 is a sample edit request page of an exemplary embodiment.

FIG. 9 is a sample of the bottom section of a verify request page of an exemplary embodiment.

FIG. 10 is a sample batch request page of an exemplary embodiment.

FIG. 11 is a sample file with requests not sent page of an exemplary embodiment.

FIG. 12 is a sample requests not sent page of an exemplary embodiment.

FIG. 13 is a sample edit requests page of an exemplary embodiment.

FIG. 14 is a sample report viewer page of an exemplary embodiment.

FIG. 15 is the sample report viewer page of FIG. 14 shown after a type of report has been selected.

FIG. 16 is a sample provider portal home page of an exemplary embodiment.

FIG. 17 is a sample provider resources page of an exemplary embodiment.

FIG. 18 is a sample provider medical records management main page of an exemplary embodiment.

FIG. 19 is a sample provider open requests page of an exemplary embodiment.

FIG. 20 is a sample open requests option screen of an exemplary embodiment.

FIG. 21 is a sample request removal screen of an exemplary embodiment.

FIG. 22 is a sample provider file upload page of an exemplary embodiment.

FIG. 23 is a sample provider recently completed requests page of an exemplary embodiment.

FIG. 24 is a system and logic diagram of an exemplary embodiment.

FIG. 25 is a system and logic diagram of an exemplary embodiment.

### DETAILED DESCRIPTION

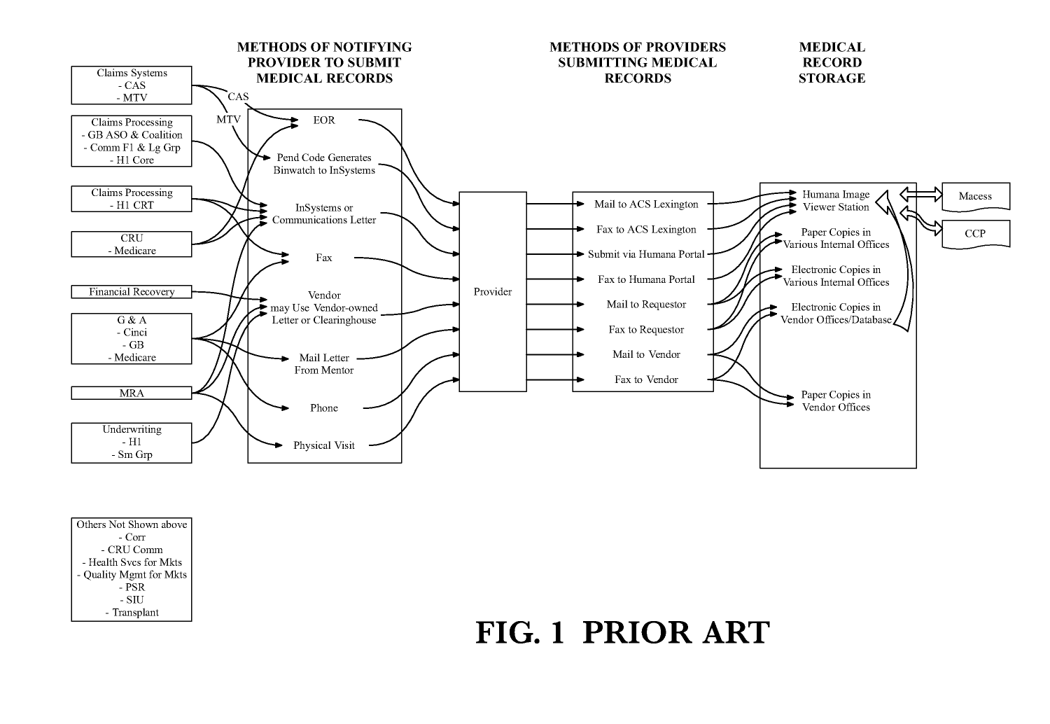

Referring to FIG. 1, a block diagram of the prior art is shown. Multiple ways of notifying providers to submit information such as medical records are used by different departments within a healthcare plan or benefits company, including phone calls, physical visits, and fax. Furthermore, the provider responds to requests for information in various ways, including through an on-line web portal, fax, and postal mail. Difficulties in tracking information also result from the different ways in which information is stored once it is provided to the healthcare plan or benefits company. The information may be stored electronically in different databases across different business units, or stored in paper copies in different business units. Overall the prior art process is confusing, duplicative, and time-consuming. Furthermore, providers may be contacted multiple times for records already received by different departments within the company.

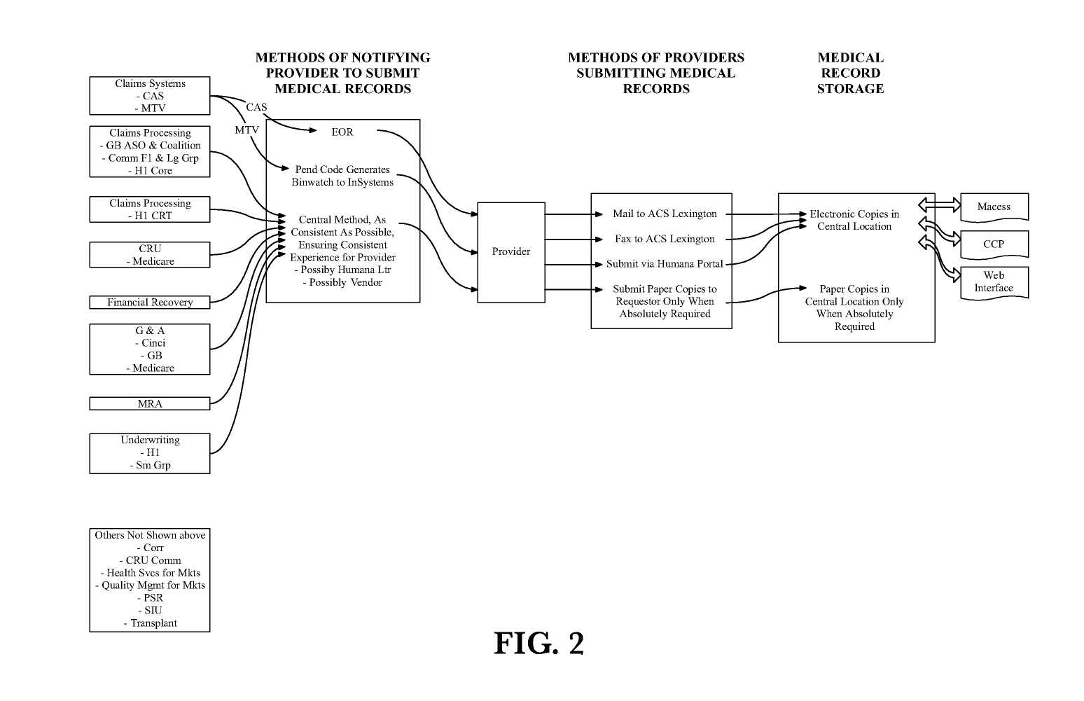

Referring to FIG. 2, a block diagram of an exemplary embodiment of a records request system is shown. As shown in this diagram, requests from different business units are consolidated and sent to providers in a few different ways. If multiple requests are to be sent to the same provider address, the records request system consolidates the requests into one mailed package, and presents a summary letter of all requests along with a detailed request for each individual member's records requested.

The providers may also use different means for submitting medical records, including mail, fax, or through an on-line portal. Medical records may be stored electronically in a central location that is accessible by web interface or other applications. Paper copies may also be stored in a central location when necessary.

In an exemplary embodiment, a web interface is used to assist a healthcare plan or benefits company in gathering requests to providers for patient information and determining which requests have been fulfilled and which are outstanding. Various users can link into the web interface to review and edit request information, as well as view records already received. Different applications used by different business units of the company may access the electronic copies that are stored in a central location.

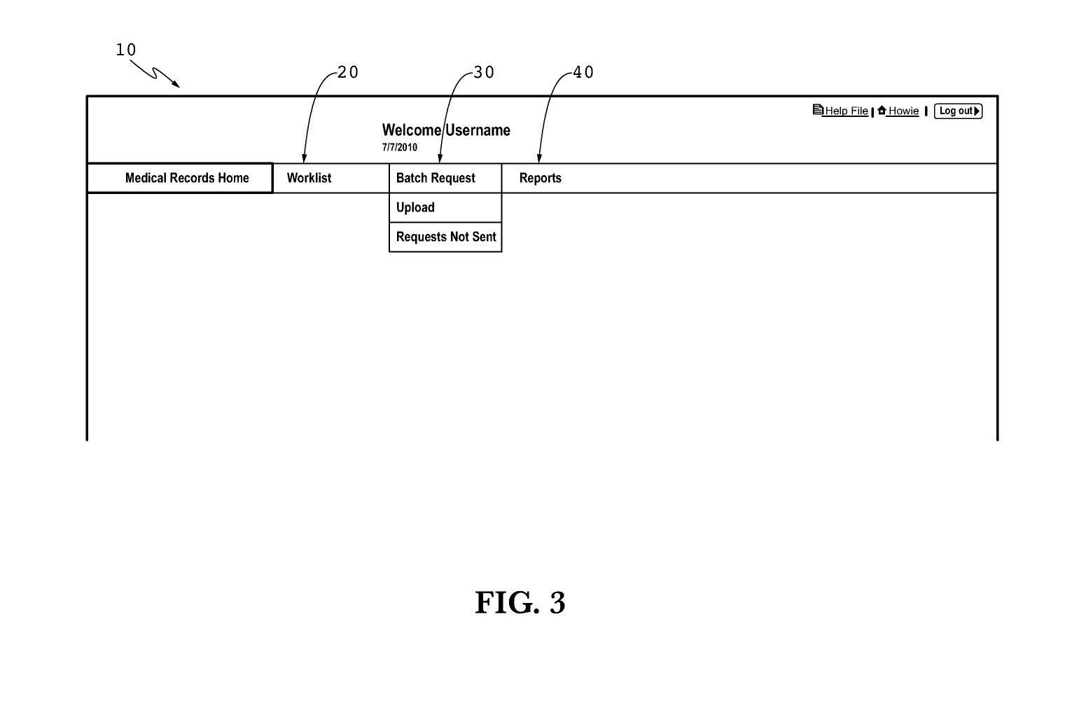

Referring to FIG. 3, a sample home page 10 of a web interface of an exemplary embodiment is shown. The web interface may be accessed by users associated with the healthcare plan or benefits company. On the home page, different buttons may be selected by the user to access different features of the portal. A worklist tab 20 may allow the user to manage existing requests. A batch request tab 30 may allow the user to upload new requests or correct invalid requests that have been uploaded into the system. In other embodiments, the system may have functionality to make requests for a single medical record.

A reports tab 40 may be used to view reports regarding request management. In some embodiments the web interface is secured to protect confidential information, and a user must enter a valid user name and/or password to access the home page 10. In other embodiments different types of security features may be used.

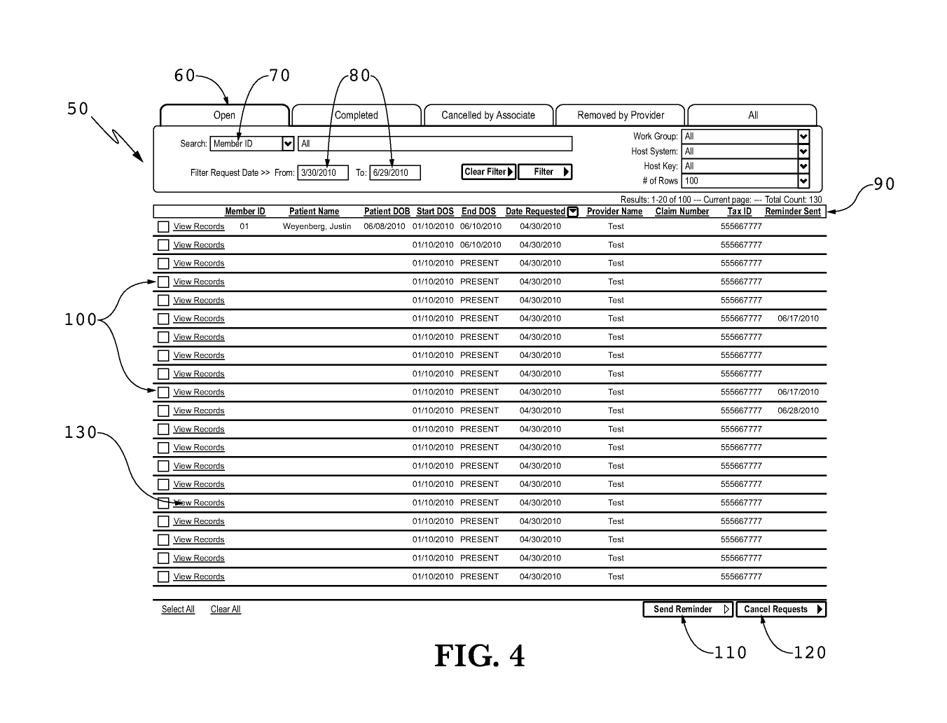

Referring to FIG. 4, a sample worklist page 50 of an exemplary embodiment is shown. The worklist page 50 may allow a user associated with the healthcare plan or benefits company to view all requests for information and perform searches for specific requests. In FIG. 4, the open tab 60 has been selected, and allows the user to view all requests that are currently pending. A drop down search menu 70 allows the user to perform searches based on different criteria, such as by a member ID, or a particular provider. Date filters 80 may allow the user to narrow their search to a particular time period. Other drop down menus may allow for further narrowing of search results, such as by work group, host system, host key. Drop down menus may also allow the user to dictate the amount of results or rows that the search generates. Buttons may allow the user to perform the search or “filtering” of information, or clear the current filter. Column headers 90 may also be selected to sort results in the desired order, and index them for easy searching. In some embodiments, searching may be performed on any of the individual components of a medical record. Searching may be done to ensure that records sought to be requested from a provider have not already been requested and/or received.

For each result that appears on the worklist page 50, the user has the option of selecting it via check boxes 100. When the user selects a particular result via the check box 100, the user can perform further actions regarding that result. For example, a user may be able to send a reminder to the provider associated with that result, reminding them to submit the requested information. This may be done through use of a send reminder button 110. The user may also cancel or withdraw a selected request by using the cancel requests button 120. Records regarding a particular result may be viewed by selecting the “view records” link 130.

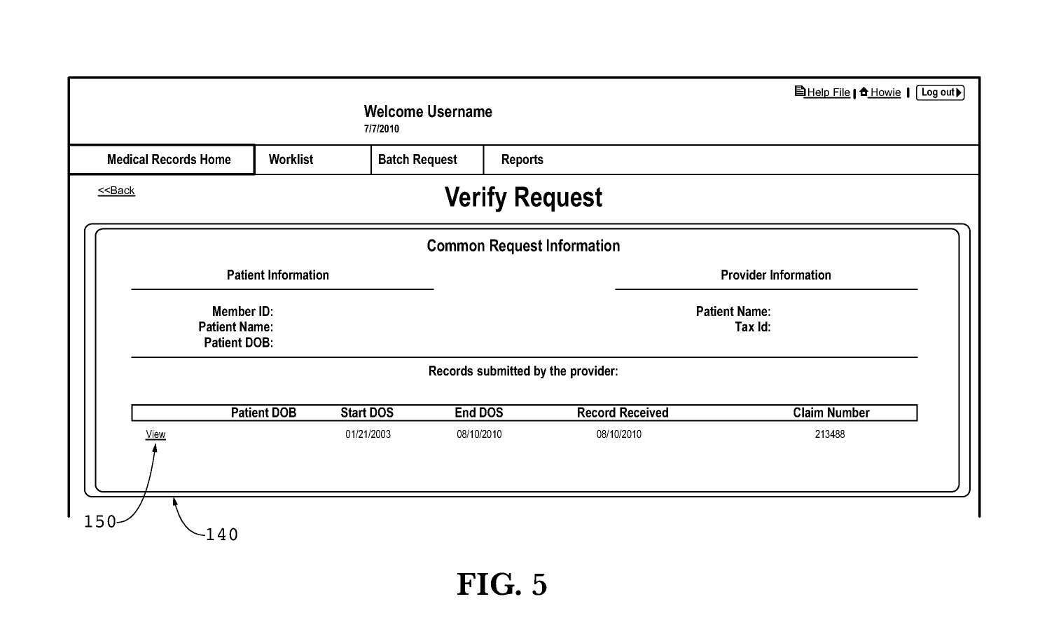

Referring to FIG. 5, a top section of a sample verify request page 140 of an exemplary embodiment is shown. This screen may be accessed by selecting the view records link 130 on the worklist page 50. This portion of the page displays the patient information, provider information, and any medical records that have been submitted by a provider. If no records have been submitted, then a statement may appear on this page informing the user that there are no records. The user may view a record by selecting a link 150 associated with the record.

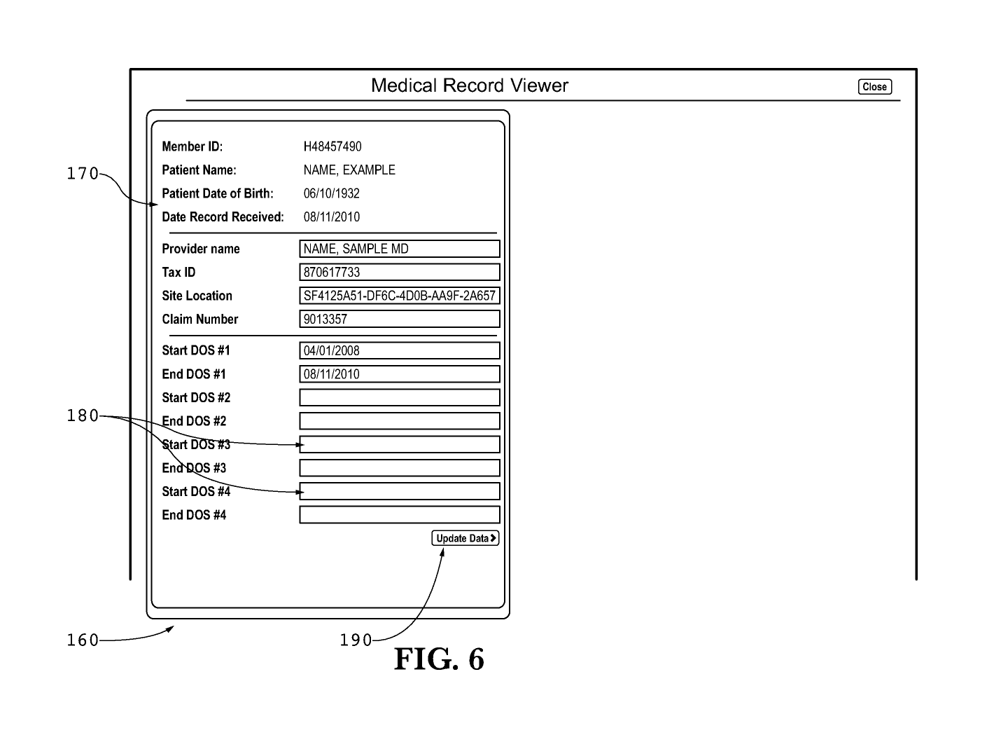

Referring to FIG. 6, a medical records viewer screen 160 of an exemplary embodiment is shown. This screen may be accessed by selecting a link associated with a particular record. Medical records may be viewed, printed, or saved. An index 170 may contain information about the record that can be used as a basis for searching. For example, the index 170 may contain the patient's name, date of birth, member identifier, or the provider's name. The index may also contain the dates of medical service received. Text fields 180 may allow the user to update or change index information from the medical records viewer screen 160. An update data button 190 may allow a user to save any changes to the index 170. A user may close the medical records viewer screen 160 and return to the verify request page 140 when finished viewing the medical record and/or making any changes.

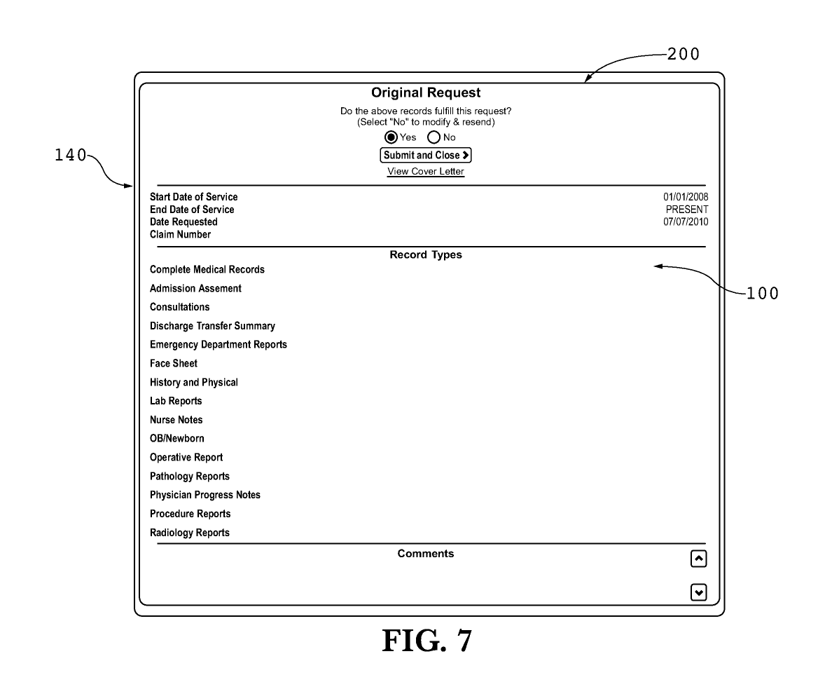

Referring to FIG. 7, a bottom section of a sample verify request page 140 of an exemplary embodiment is shown. An original request screen 200 shows the details surrounding a particular request for information, including basic information about the service, the types of information or reports provided, and any comments sent to the provider. A user viewing this screen can determine if the records already requested meet the user's needs. The provider's experience may be improved by avoiding additional requests for the same records. Records requested may be designated by check boxes 100 associated with different types of records. If the records already requested do not meet a user's particular needs, then the user can access a new screen that will allow the user to edit and resend the request to the provider.

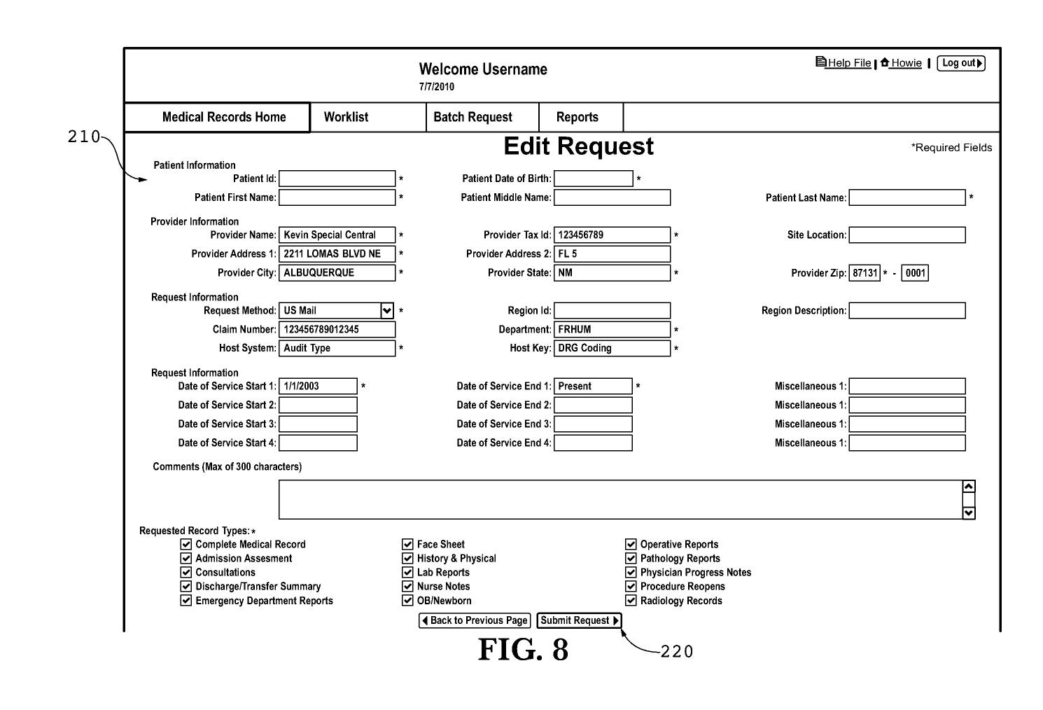

Referring to FIG. 8, a sample edit request page 210 according to an exemplary embodiment is shown. The edit request page 210 allows a user to change information regarding a request, including the types of records requested. When a user accesses this page, it may already be pre-filled with information regarding the original request. The type of information a user may be able to edit includes patient information, provider information, request information, comments regarding the request, and requested record types. After editing any information the user may select a Submit Request button 220 to resubmit the request as edited. In some embodiments, tracking features may ensure that duplicative requests are not entered into the system.

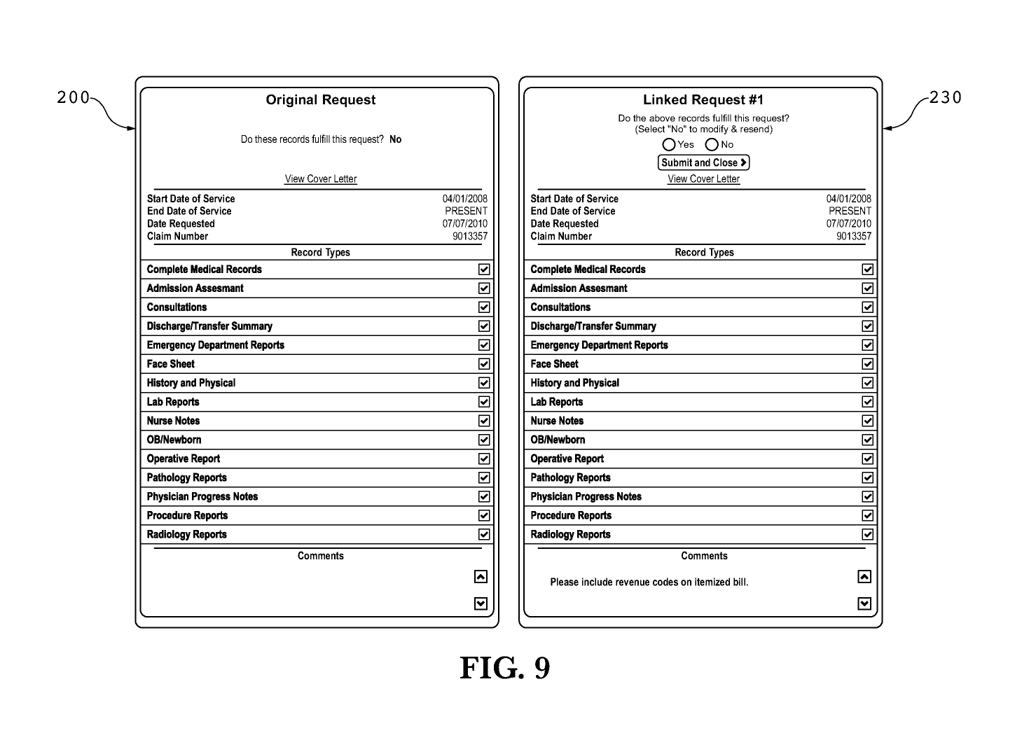

After edited requests are sent, they may appear as linked requests to the original request. Referring to FIG. 9, a bottom section of a sample verify request page of an exemplary embodiment is shown. In this figure, an original request screen 200 is located next to a linked request screen 230. The linked request screen 230 may be edited in the same way as the original request screen 200. Limits may be imposed on how many times a request can be edited before a new request will need to be created instead.

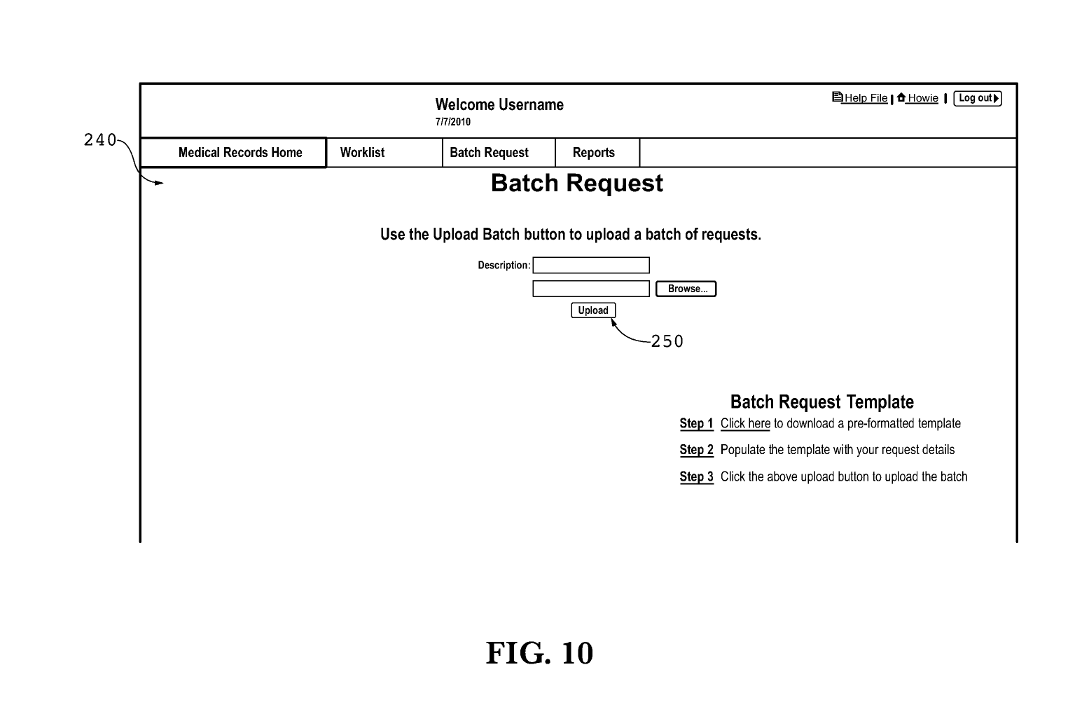

It may become necessary for a user to upload a new request file. Referring to FIG. 10, a sample batch request screen 240 of an exemplary embodiment is shown. This screen may allow the user to upload a batch of requests at once, instead of having to create multiple medical record requests one-by-one. Through text boxes, the user can enter a brief description of the batch file. The user can either create a new batch file or locate an existing batch file on the network. Templates may be provided to assist the user in creating the requests. Once the user has obtained the batch file, they may select the upload button 250 to begin the upload process. While in this embodiment a user uploads request files, in other embodiments a user may create requests within the system by filling out electronic forms through the web interface. In different embodiments requests may be entered in other ways as well.

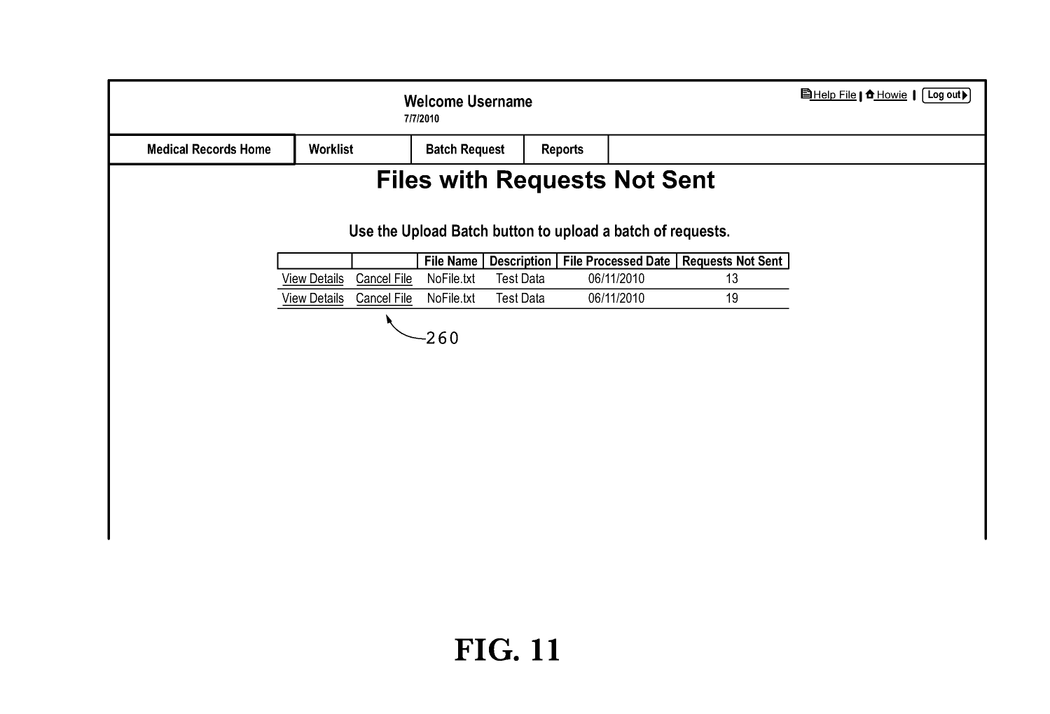

Referring to FIG. 11, a sample files with requests not sent page 260 of an exemplary embodiment is shown. This page may provide the user with a list of requests that have been made but not sent to the provider. Links on this page may allow the user to view details of the identified requests, or cancel the requests.

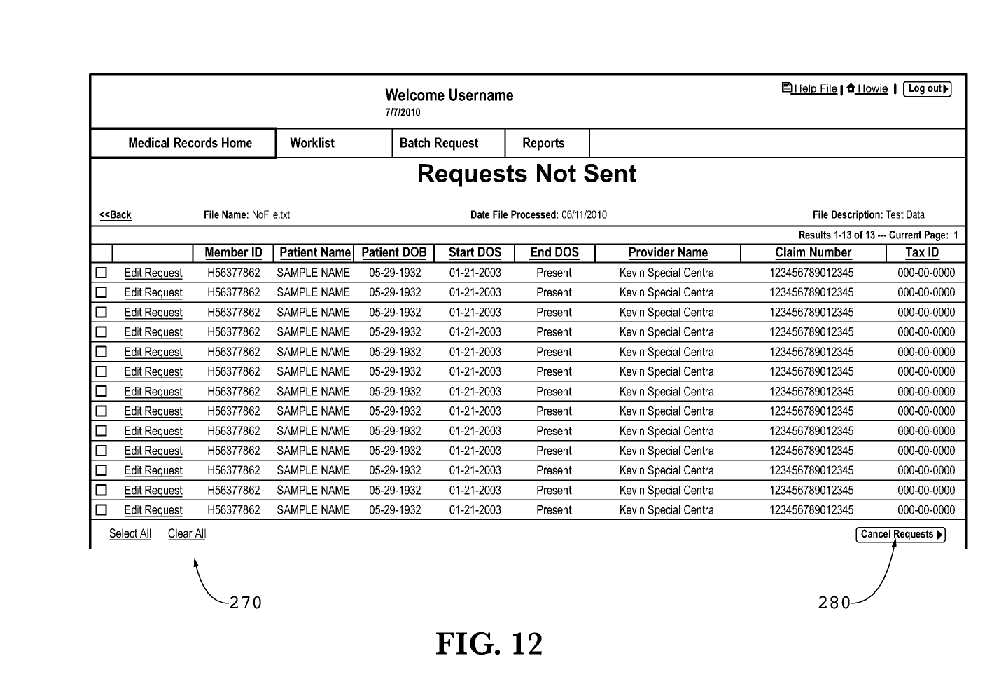

Referring to FIG. 12, a sample requests not sent page 270 of an exemplary embodiment is shown. This page may be accessed by selecting a link on the files with requests not sent screen 260. Through this page the user can select individual requests to review and edit. The user can also cancel individual requests by selecting individual requests and using the cancel requests button 280.

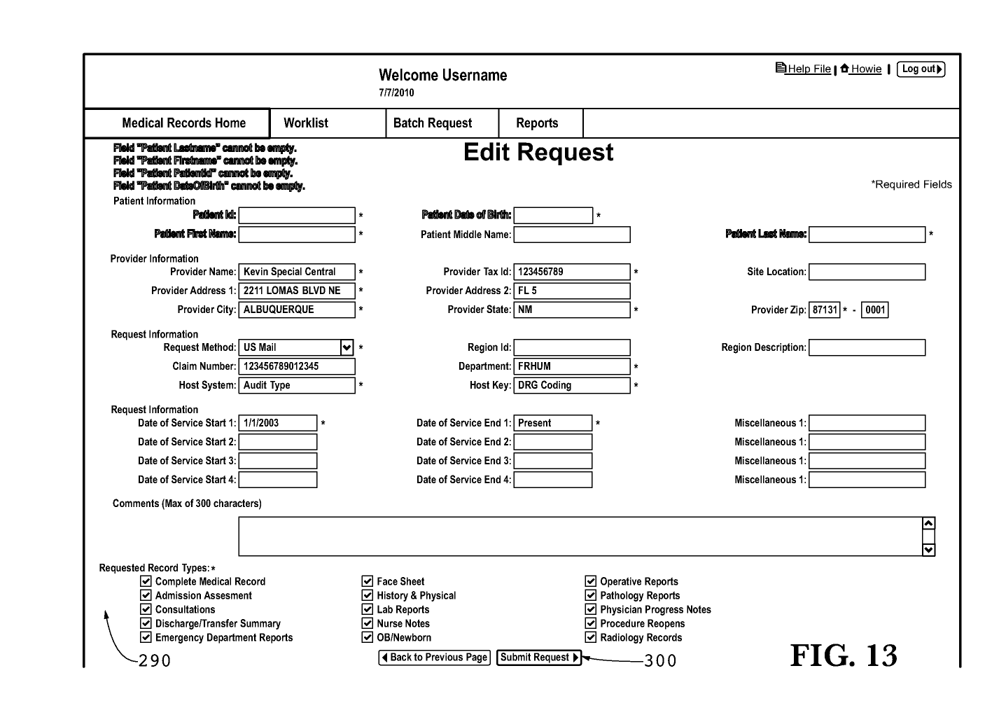

Referring to FIG. 13, a sample edit requests page 290 of an exemplary embodiment is shown. This page may be accessed by editing a file on the requests not sent page 270. As shown in this figure, requests may not be sent when errors are present in the request. For example, if required information such as patient's identifier, first or last name, or date of birth is not provided, the request may not be sent. By viewing this page the user can correct problems with the request so that it can be sent. Once the user has corrected any problems, the submit request button 300 may be used to submit the request.

The system may generate notices that are sent to a provider. In some embodiments the provider receives notices through the web portal or through other electronic means such as e-mail. Some embodiments of the system may also generate paper notices that can be mailed or faxed to a provider. Appendix A contains sample notices that may be generated by exemplary embodiments of the system. In some embodiments, information contained in the system may be used to automatically generate notices that include the provider's name and address, member name, member identifier, and date of birth. Other information may also be automatically included on notifications generated by the system. In some embodiments, the system may not only track how long requests have been pending, but how long it has been since notices have been sent. This capability allows for follow-up notices to be generated that indicate to the provider that the information has previously been request. As seen in Appendix A, some notices may say that they are “final notices,” or otherwise indicate that this is not the first time the information has been requested. In some embodiments a user of the system can change the timing for automatically generating notices as desired.

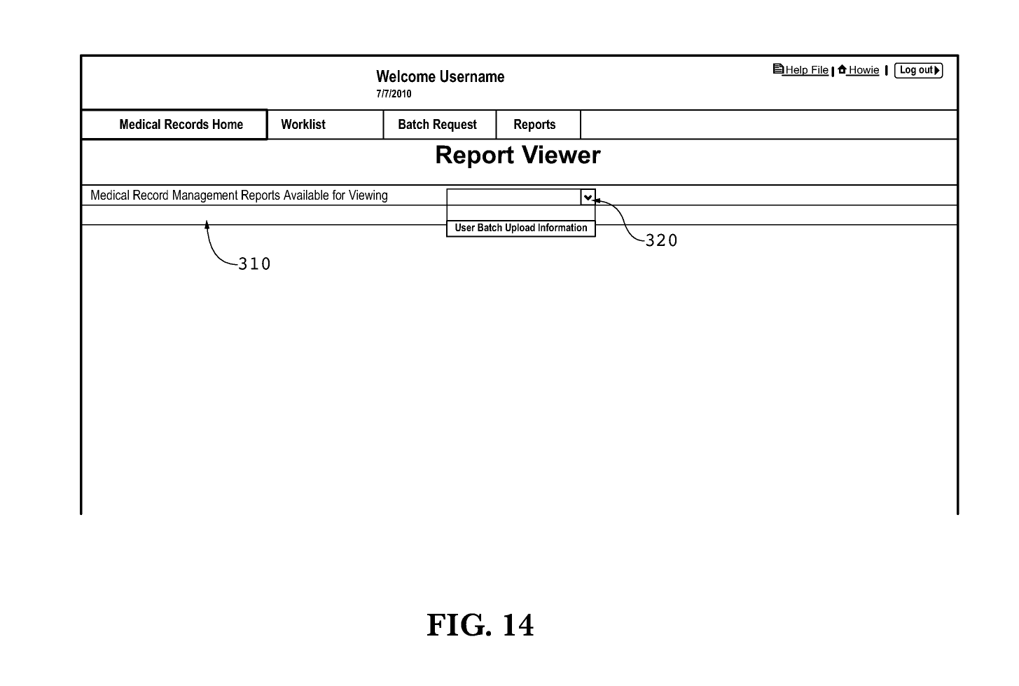

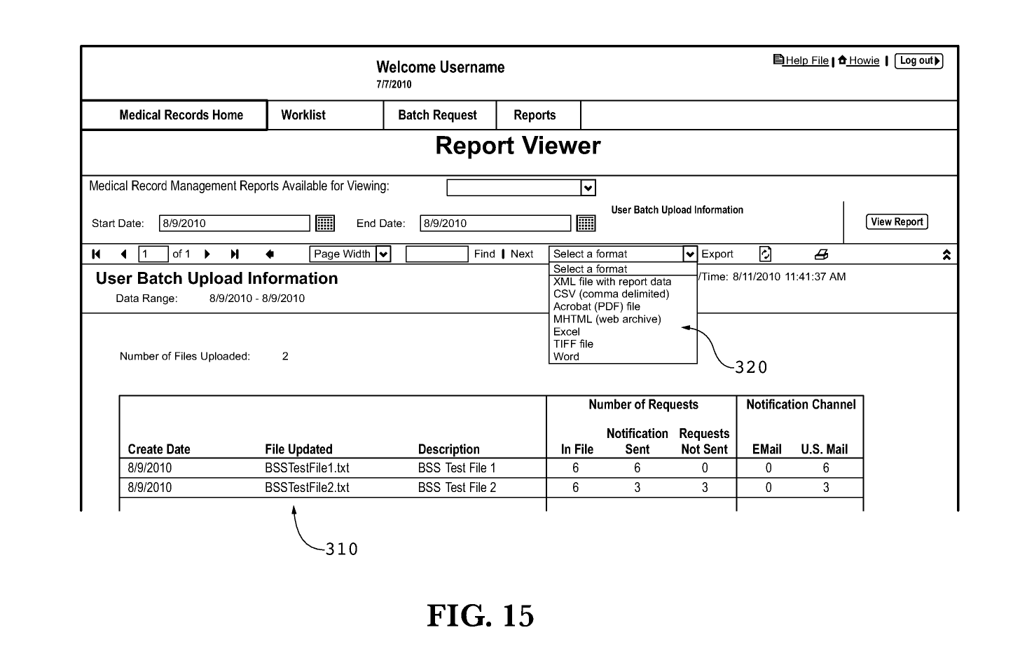

It may be desirable to review reports regarding the requests that have been made to providers and the records that have been received in return. Referring to FIG. 14, a sample report viewer page 310 of an exemplary embodiment is shown. On this page the user may select the type of report he or she wishes to view using a drop-down menu 320. Referring to FIG. 15, the sample report viewer page 310 of FIG. 14 is shown after a type of report has been selected. In this figure, the user has selected an option to view the user batch upload information report. A drop-down menu 320 allows the user to change the report format type. Other options allow the user to view a different date range for the report, and print the report. The report shown in FIG. 14 shows the user how many requests are in the file, how many notifications about the requests have been sent, how many requests have not been sent, and the notification channel (e-mail or U.S. mail). In other embodiments, different types of information may be provided in the reports generated by the system, including different analyses of how the medical records management process is performing, or medical records costs.

While users may access the system through a web interface, in some embodiments, other means for accessing the system may also be used. Users on a common network may not need to access a web interface, but simply access a common shared server. In other embodiments different system structures may allow different users, whether remote to one another or not, to access a shared records request system.

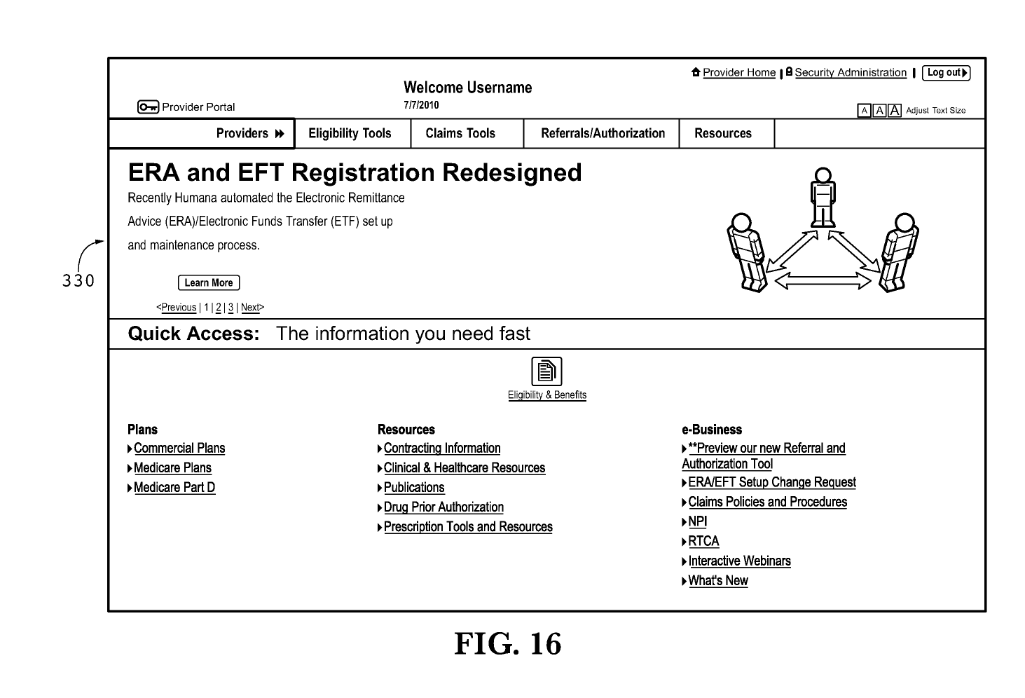

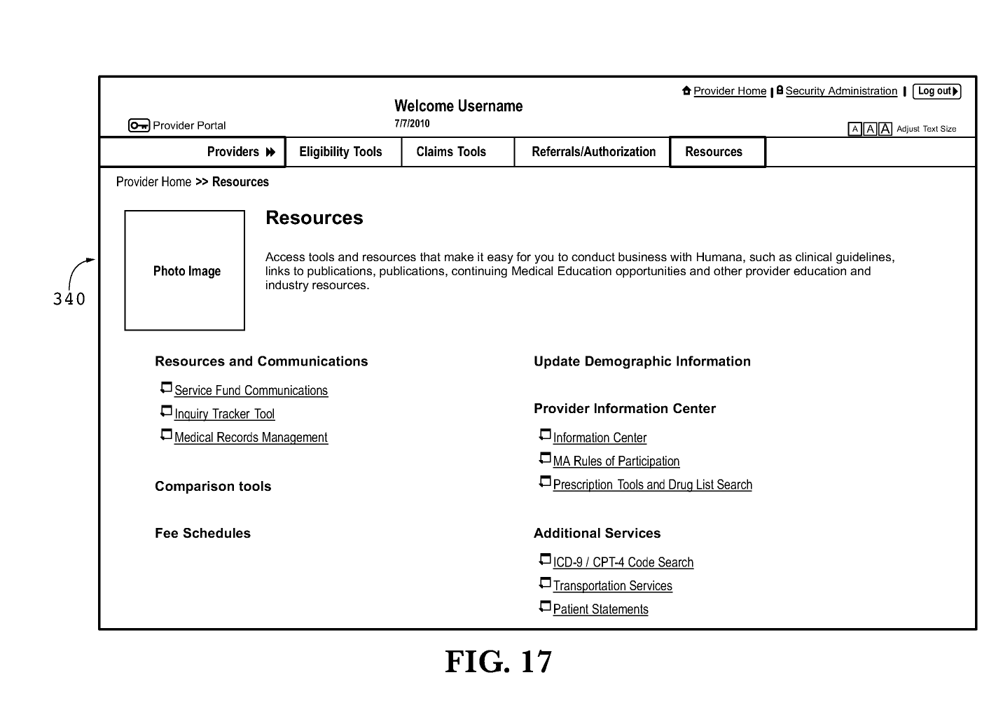

A provider may also be able to access the system, such as through a web portal, in order to view requests and upload information and records responsive to requests. Referring to FIG. 16, a sample provider portal home page 330 of an exemplary embodiment is shown. In order for a provider to access a provider portal such as the one shown, it may be necessary for the provider to log in to the portal by entering a user name and password. The login and other types of security features may ensure that only authorized provider personnel are viewing and transmitting information regarding a patient's medical records. Referring to FIG. 17, a sample provider resources page 340 of an exemplary embodiment that may be accessed from a provider portal home page 330 is shown. From this page a provider may access medical records management.

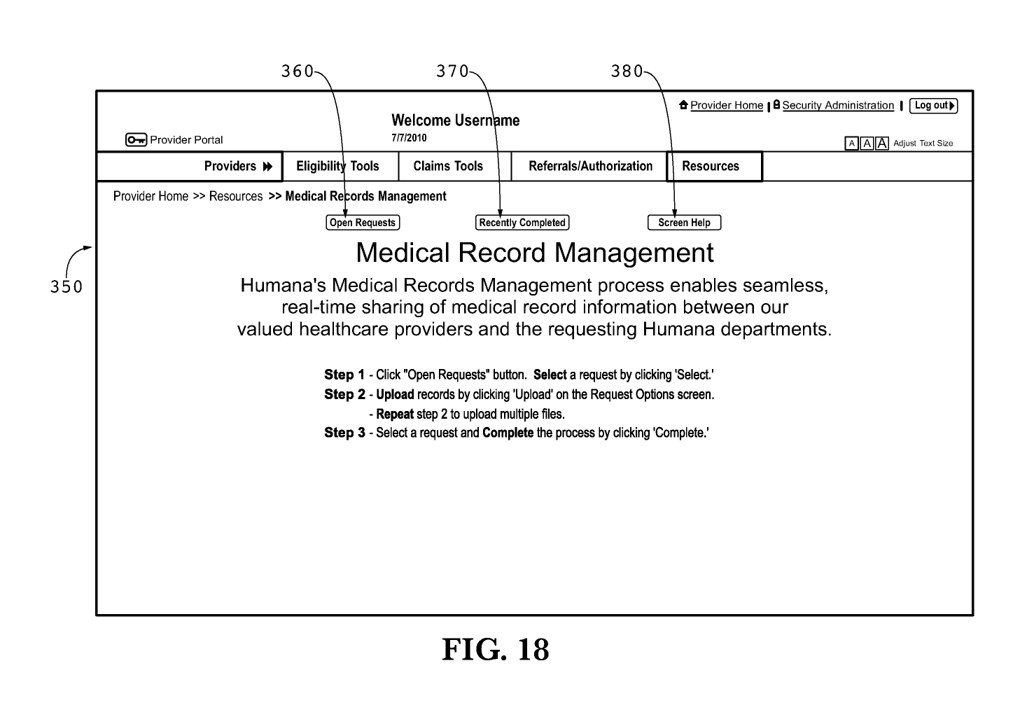

Referring to FIG. 18, a sample provider medical records management main page 350 according to an exemplary embodiment is shown. This page may allow the provider to perform different actions regarding fulfilling requests for records. First, the provider may select the open requests button 360 in order to review requests that have not yet been fulfilled. A recently completed button 370 may allow the user to access requests that have not been fulfilled. A screen help button 380 may allow the user to view pages with information on how to navigate the medial records management system.

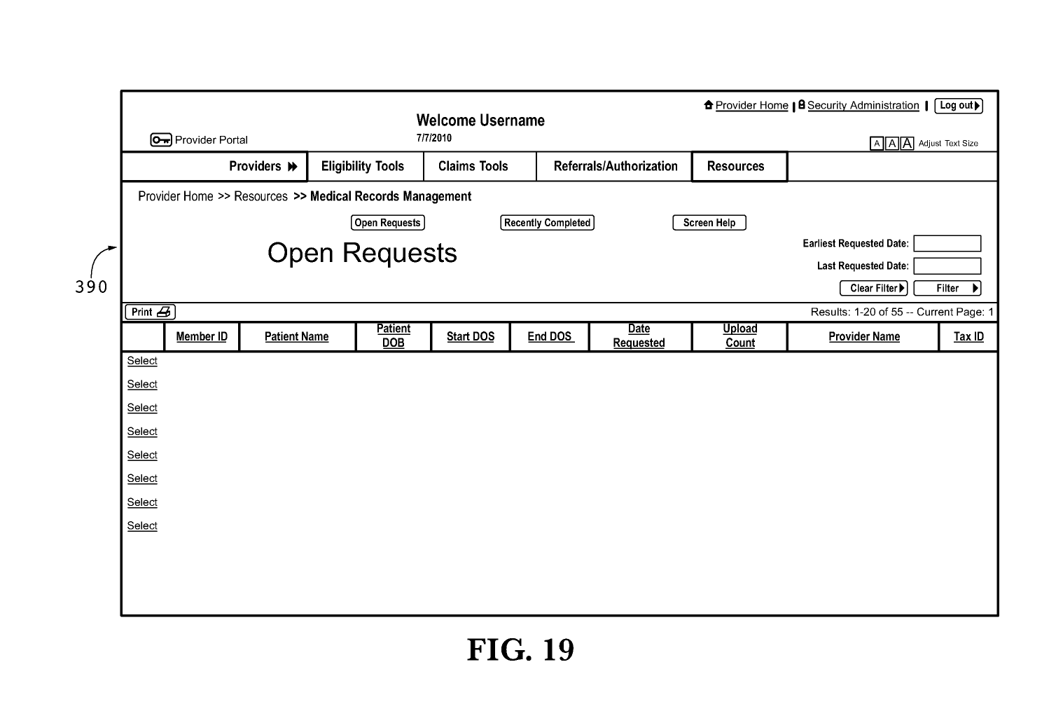

Referring to FIG. 19, a sample provider open requests page 390 of an exemplary embodiment is shown. This page allows the provider to view those requests that are open and have not been fulfilled. Results can be filtered according to different time-periods, and results can be sorted by selecting different column headers. Depending on the embodiment, the presentation of results to the provider may indicate whether particular requests are new or pending requests. For example, in some embodiments new requests that have not been viewed may be displayed in bold font. In other embodiments, different ways of identifying status of requests may be used. Various columns of information may be present and identified with column headers. The types of information may include member identifiers of patients whose records are requested (“Member ID” column); names of patients whose records are requested (“Patient Name”); date of birth for patients whose records are requested (“Patient DOB”); oldest dates of service for the records requested (“Start DOS”); latest, most recent dates of service for the records requested (“End DOS”); date the request was generated from the requesting company (“Date Requested”); number of images uploaded by the provider into the medical records management system (“Upload Count”); name of the physician, practice, or facility providing the records (“Provider Name”); and tax identification numbers of the physician, practice, or facility providing the records (“Tax ID”).

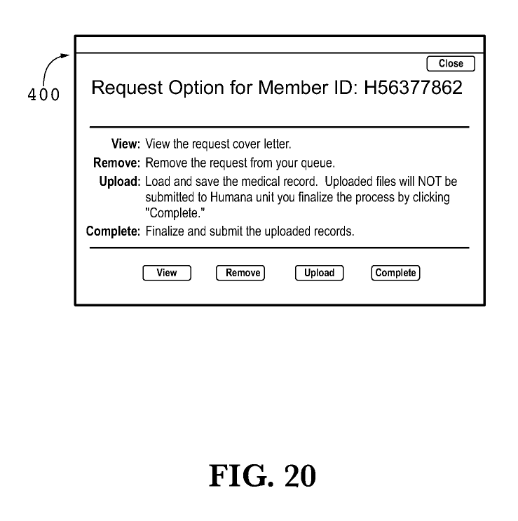

Referring to FIG. 20, a sample open requests options screen 400 of an exemplary embodiment is shown. This screen may be accessed from a link on the open requests page 390. This screen may allow the provider to perform several different actions regarding a request. For example, the options screen 400 may allow the user to view the request cover letter, remove the request from a queue, or upload and save a medical record. Once a provider has performed the desired actions, they may complete the process by finalizing and submitting any uploaded records. Buttons located on the bottom of the screen may assist the user in viewing, removing, and uploading any records, as well as completing the record submitting process.

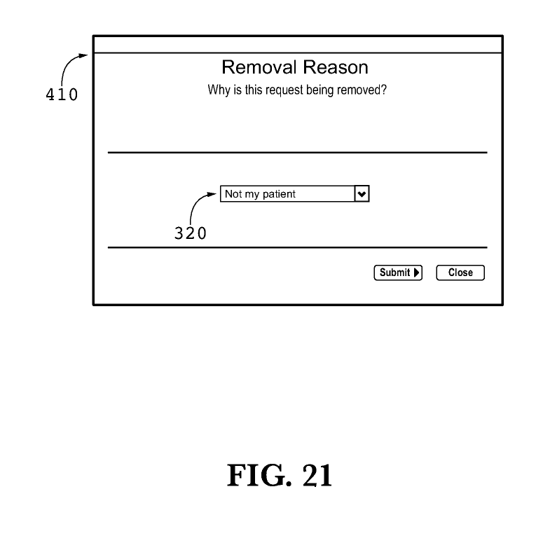

Referring to FIG. 21, a sample request removal screen 410 of an exemplary embodiment is shown. This screen may be viewed when the provider selects a “removal” button on the open requests options screen 400. This screen may allow the provider to select a reason from a drop-down menu 320 indicating why a received request has been removed. The reasons a provider may have for removing a request may include the following: the request identifies a person that is not a patient of that particular provider; the provider cannot fulfill the request for information; the provider is sending its records or other information through U.S. mail or fax instead; the provider requests that the healthcare plan or benefits company send a representative in person to obtain the records; or the provider prefers that it receive a request in the mail. Many other reasons may exist for why a provider would choose to delete a particular request for medical records. Once a provider submits its decision to remove a request, that request may no longer be viewable on the portal to the provider.

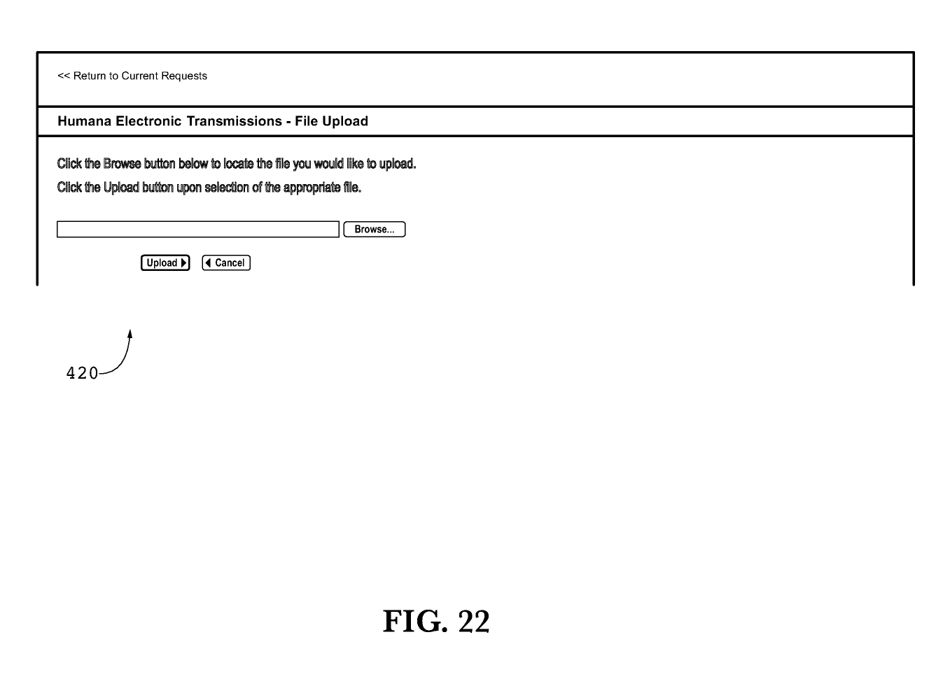

Referring to FIG. 22, a sample provider file upload page 420 of an exemplary embodiment is shown. This screen may allow the provider to browse for and upload documents responsive to a particular request. This page may be accessed when the provider selects an “upload” option on the open requests options screen 400.

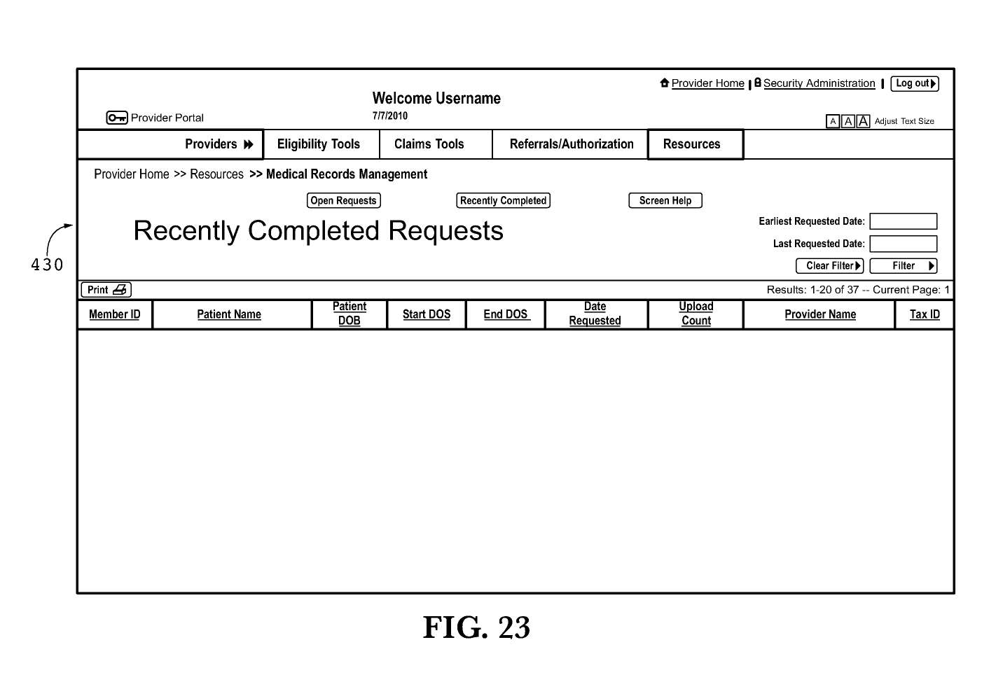

Referring to FIG. 23, a sample recently completed requests page 430 of an example embodiment is shown. This page may be accessed from the medical records management main page 350 or other pages or screens. This page may show the provider requests that have previously been completed. Depending on the embodiment, completed requests for a past period of time may be shown, such as for the past 90 days. As with other pages, the request list can be sorted by selecting different column headers, or filtering requests by date.

In different embodiments a provider may communicate with a healthcare plan or benefits company in different ways. For example, a provider may receive notifications of requests for records through electronic means, such as through an on-line portal or e-mail, or a provider may receive requests through facsimile, mail, or over the phone. In some embodiments, a provider that receives requests through non-electronic means may provide records or other information in response through electronic means, such as an on-line portal or e-mail. In some embodiments where a provider receives requests through non-electronic means, the healthcare plan or benefits company may nevertheless queue requests, consolidate requests, track requests pending, share information about requests pending, and store records once received so that they may be accessed by various users.

In those embodiments where a provider fills requests for information by fax, mail, or other non-electronic means, once the healthcare plan or benefits company receives those records it may scan them in to its electronic system so that they can be viewed on-line by various users.

In some embodiments an on-line portal may be maintained by a third party entity to the healthcare plan or benefits company.

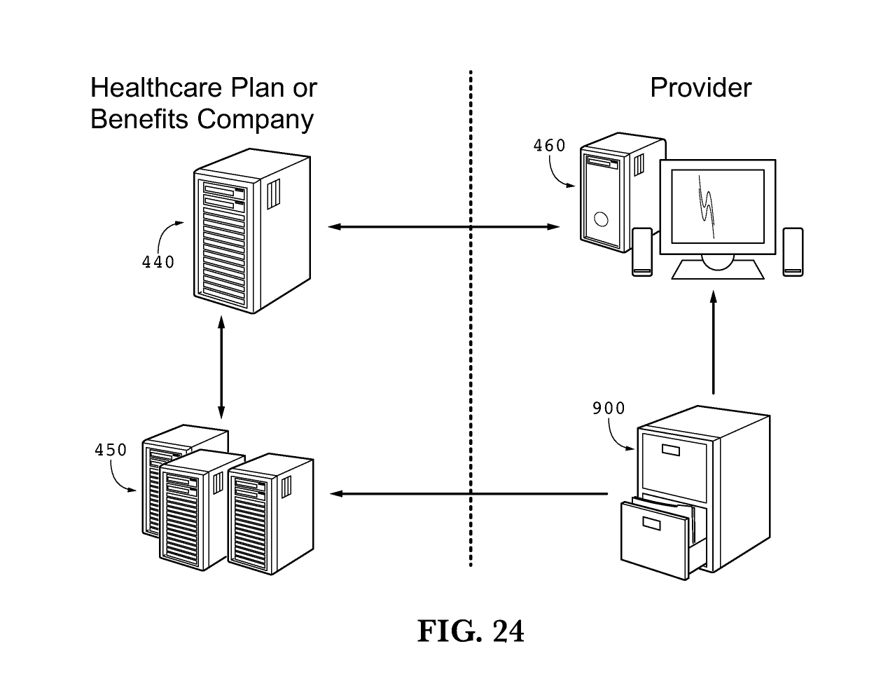

Referring to FIG. 24, a system and logic diagram of an exemplary embodiment is shown. A central server 440 associated with a healthcare plan or benefits company may support an on-line system for requesting medical records or other information from a provider. The central server 440 may be accessed over a network and/or over the internet by users associated with various business unit systems 450 within the healthcare plan or benefits company. Users may access information contained on the central server 440 regarding requests for medical records or other information. Different business unit systems 450 may also pull information contained on the central server 440 to run applications associated with particular business units. A provider computer 460 is able to remotely access the central server 440 via an on-line portal or other means. Through the provider computer 460, requests for medical records and other information can be viewed and fulfilled. Records and information already stored electronically may be sent to the central computer 440 in electronic form.

Hard copy medical records 900 may be scanned by the provider and electronically sent to the central server 440 to fill requests. Hard copy medical records 900 may also be mailed or sent via facsimile to the healthcare plan or benefits company, where they are scanned with index data to allow for search at a later time by other users and electronically saved in the central server 440 by the business unit systems 450. Alternatively, hard copy medical records may be sent to a copy service company with which the benefits company interacts. The system may provide functionality for electronically requesting and receiving records from the copy service company, enabling maximum value for both parties while reducing provider workload.

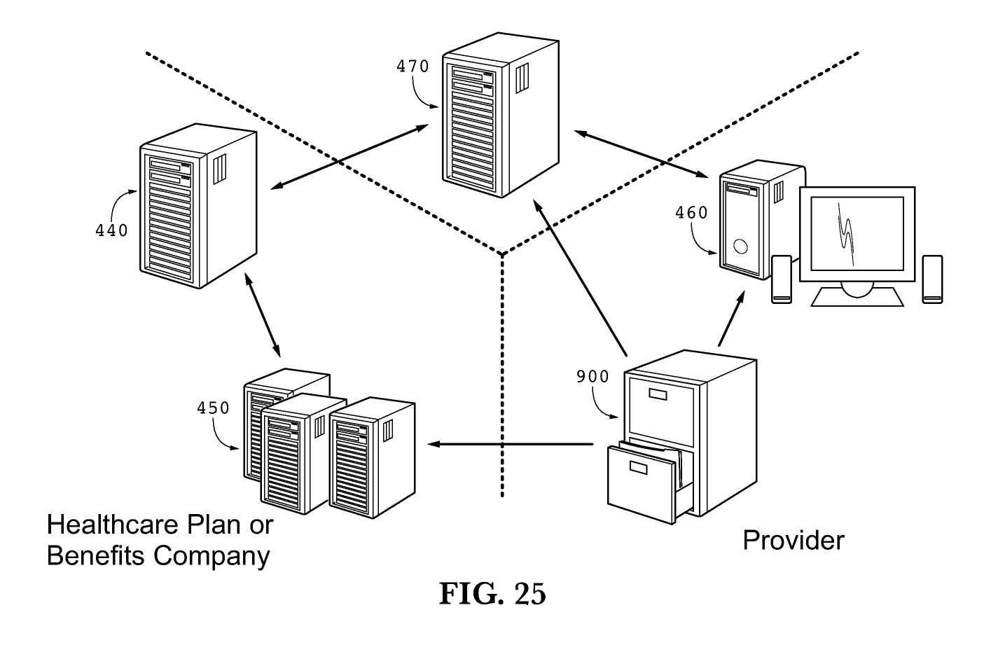

Referring to FIG. 25, a system and logic diagram of an exemplary embodiment is shown. In this system, an intermediary server 470 remote to the healthcare plan or benefits company and the provider maintains an on-line portal or website. This intermediary server 470 may be operated by a third party to both the healthcare plan or benefits company and the provider. The intermediary server 470 may support an on-line portal for medical records management. The intermediary server may receive information regarding requests from the central server 440 and forward those requests along to the provider. The intermediary server may transmit records received from a provider computer 460 to the central server 440. In some embodiments hard copy medical records 900 from a provider may be uploaded to the intermediary server 470 in order to be accessed by a healthcare plan or benefits company. In FIG. 24, business unit systems 450 communicate requests and receive medical records from central server 440. However, in other embodiments the business unit systems 450 may also communicate requests to and receive records from the intermediary server 470.

While certain embodiments of the present invention are described in detail above, the scope of the invention is not to be considered limited by such disclosure, and modifications are possible without departing from the spirit of the invention as evidenced by the claims. For example, computer systems different from those shown in the figures may be used to perform the objectives of the claimed invention. Also, different types of web portals or other on-line systems from those discussed above may be used to solicit and receive medical records or other information as set forth in the claims. Other embodiments of the present invention may not involve the health field or medical records, but may apply to any industry where records or other information is being sought from third parties. One skilled in the art would recognize that such modifications are possible without departing from the scope of the claimed invention.

1. A computerized system for managing patient information, comprising:
a server on a network executing instructions to:
(a) receive at said server from each of a plurality of computer users a plurality of patient information requests, each of said patient information requests comprising user selections of:
(1) a provider identifier for a provider of said patient information;
(2) a patient identifier for a patient of said provider;
(3) at least one medical record type selected from the group consisting of:
complete medical record; admission assessment; consultation;
discharge/transfer; emergency report; face sheet; history and physical report;
lab reports; nurse notes; obstetrics report; newborn report; operative report;
pathology report; physician progress notes; procedure reports; and radiology reports; and
(4) a provider notification method selected from the group consisting of:
postal mail, electronic mail, facsimile, and hardcopy;
(b) compare at said server data in each of said patient information requests to identify duplicative patient information requests;
(c) for said duplicative patient information requests to be sent to a same provider address,
(1) generate at said server a consolidated patient information request comprising data from said plurality of patient information requests wherein duplicate data requests have been removed from said consolidated patient information request;
(2) store in a database said consolidated patient information request;
(d) initiating from said server to said provider a transmission of said consolidated patient information request according to said provider notification method;
(e) receive at said server from said provider in response to said consolidated patient information request patient information consistent with said patient identifier and said medical record type;
(f) store in said database said patient information from said provider; and
(g) provide at said server said plurality of computer users with access to a work list page comprising:
(1) summary data for said plurality of patient information requests;
(2) summary data for said stored consolidated patient information request; and
(3) for each patient information request, a view records link for accessing additional links to said stored patient information responsive to said patient information request.

2. The computerized system for managing patient information of claim 1, further comprising:
a provider computer in communication with said server for receiving from said server said consolidated patient information request.

3. The computerized system for managing patient information of claim 2, wherein said server receives from said provider computer a delete request to delete said consolidated patient information request.

4. (canceled)

5. The computerized system for managing patient information of claim 1, wherein said patient information request further comprises at least one date of service start and date of service end.

6. (canceled)

7. (canceled)

8. The computerized system for managing patient information of claim 1, wherein said server supports uploading a batch of patient information requests.

9. A computerized method for managing patient information from a provider, comprising the steps of:
(a) receiving at a server from each of a plurality of computer users a plurality of patient information requests, each of said patient information requests comprising user selections of:
(1) a provider identifier for a provider of said patient information;
(2) a patient identifier for a patient of said provider;
(3) at least one medical record type selected from the group consisting of:
complete medical record; admission assessment; consultation;
discharge/transfer; emergency report; face sheet; history and physical report;
lab reports; nurse notes; obstetrics report; newborn report; operative report;
pathology report; physician progress notes; procedure reports; and radiology reports; and
(4) a provider notification method selected from the group consisting of:
postal mail, electronic mail, facsimile, and hardcopy;
(b) comparing at said server data in each of said patient information requests to identify duplicative patient information requests;
(c) for said duplicative patient information requests to be sent to a same provider address,
(1) generate at said server a consolidated patient information request comprising data from said plurality of patient information requests wherein duplicate data requests have been removed from said consolidated patient information request;
(2) storing in a database said consolidated patient information request;
(d) initiating from said server to said provider a transmission of said consolidated patient information request;
(e) receiving at said server from said provider in response to said consolidated patient information request patient information consistent with said patient identifier and said medical record type;
(f) storing in said database said patient information from said provider; and
(g) providing at said server said plurality of computer users with access to a work list page comprising:
(1) summary data for said plurality of patient information requests;
(2) summary data for said stored consolidated patient information request; and
(3) for each patient information request, a view records link for accessing additional links to said stored patient information responsive to said patient information request.

10. The computerized method for managing patient information of claim 9, further comprising receiving at said server from a provider computer a delete request to delete said consolidated patient information request.

11. (canceled)

12. The computerized method for managing patient information of claim 9, wherein said patient information request further comprises at least one date of service start and date of service end.

13. (canceled)

14. (canceled)

15. The computerized method for managing patient information of claim 9, further comprising receiving at said server a batch of patient information requests.

16. (canceled)

17. (canceled)

18. (canceled)

19. (canceled)

20. (canceled)
